(19) United States
(12) Patent Application Publication
(10) Pub. No.: US 2013/0108795 A1
(43) Pub. Date: May 2, 2013

(54) Method of Manufacturing Natural, Breathable and Quick Drying Fabric

(71) Applicants: Shih Ching Hung, Taipei City (TW); Chih-Chang Hsu, Taipei City (TW)

(72) Inventors: Shih Ching Hung, Taipei City (TW); Chih-Chang Hsu, Taipei City (TW)

(73) Assignee: RUENTEX INDUSTRIES LTD., Taipei City (TW)

(21) Appl. No.: 13/281,483

(22) Filed: Oct. 26, 2011

(51) Int. Cl. B05D 3/02; B05D 1/00; B05D 1/18

(52) U.S. Cl. 427/397.7; 427/434.2; 427/443

(57) ABSTRACT

A hydrophobic auxiliary, a hydrophilic auxiliary and a penetrant agent are applied to manufacture a fabric. Both hydrophilicity and hydrophobicity are thus obtained at the same time for the fabric. Water absorbed by the fabric is spread in a stereo way. Conclusively, hygroscopicity is kept with a constant function of quick drying.

### TECHNICAL FIELD OF THE INVENTION

The present invention relates to manufacturing a fabric; more particularly, relates to obtaining both hydrophilicity and hydrophobicity at the same time for the fabric, where water absorbed by the fabric is spread in a stereo way to keep hygroscopicity and obtain a constant function of quick drying.

### DESCRIPTION OF THE RELATED ART

A waterproof fabric is usually obtained by weaving a fiber in a specific way for obtaining a good spreading effect after absorbing water. Yet, the specific way for weaving is usually complex and complicated. As a result, water absorbed by a traditional fabric is spread in a planar way with a bad spreading effect. Hence, the prior art does not fulfill all users' requests on actual use.

### SUMMARY OF THE INVENTION

The main purpose of the present invention is to obtaining both hydrophilicity and hydrophobicity at the same time for a fabric, where water absorbed by the fabric is spread in a stereo way to keep hygroscopicity and obtain a constant function of quick drying.

To achieve the above purpose, the present invention is a method of manufacturing a natural, breathable and quick drying fabric, comprising steps of: (a) obtaining a setting unit, where the setting unit has a containing area; the containing area contains a first filling unit, a second filling unit, a third filling unit and a drying unit; and the first filling unit, the second filling unit and the third filling unit are filled with a hydrophobic auxiliary, a hydrophilic auxiliary and a penetrant agent, respectively; (b) obtaining a desized fabric in the containing area of the setting unit; (c) filling the hydrophobic auxiliary into the containing area through the first filling unit to process the fabric with the setting unit and then to hot-drying the fabric with the drying unit; and (d) filling the hydrophilic auxiliary and the penetrant agent into the containing area through the second filling unit and the third filling unit, respectively, to process the fabric with the setting unit and then to hot-drying the fabric. Accordingly, a novel method of manufacturing a natural, breathable and quick drying fabric is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the view showing step (a) of the preferred embodiment according to the present invention;

FIG. 2 is the view showing step (b) of the preferred embodiment;

FIG. 3 is the view showing step (c) of the preferred embodiment; and

FIG. 4 is the view showing step (d) of the preferred embodiment.

### DESCRIPTION OF THE PREFERRED EMBODIMENT(S)

The following description of the preferred embodiment is provided to understand the features and the structures of the present invention.

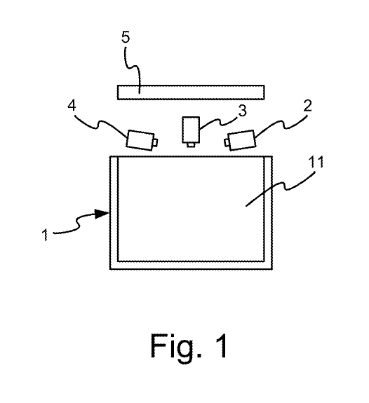

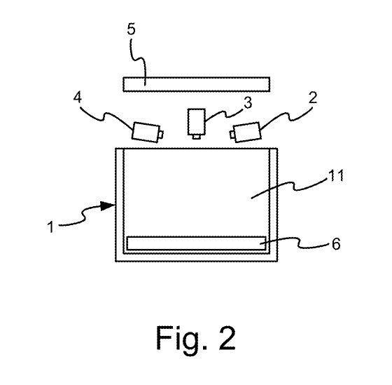

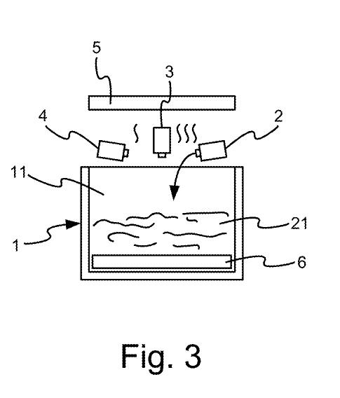

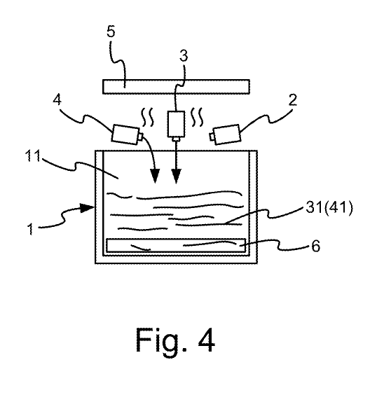

Please refer to FIG. 1 to FIG. 4, which are views showing step (a) to step (d) of the preferred embodiment according to the present invention. As shown in the figures, the present invention is a method of manufacturing a natural, breathable and quick drying fabric, comprising the following steps:

(a) A setting unit 1 having a containing area 11 is obtained. The containing area 11 contains a first filling unit 2, a second filling unit 3, a third filling unit 4 and a drying unit 5; and, the first filling unit 2, the second filling unit 3 and the third filling unit 4 are filled with a hydrophobic auxiliary 21, a hydrophilic auxiliary 31 and a penetrant agent 41, respectively.

(b) A desized fabric 6 is put in the containing area 11 of the setting unit 1, where the fabric 6 is obtained by weaving a natural hydrophilic fiber and the natural fiber is a plant fiber, an animal fiber or a mineral fiber.

(c) The hydrophobic auxiliary 21 is filled into the containing area 11 through the first filling unit 2 to process the fabric 6 with the setting unit 1 under a pick-up ratio of 50%˜58% and then to hot-drying the fabric 6 with the drying unit 5 under a temperature of 130° C.˜180° C. for a time period of 1˜10 minutes (min). Therein, the hydrophobic auxiliary 21 has a ratio of 0.1%˜10% to water; and, the hydrophobic auxiliary 21 is a wax, a sulphoisophthalic polymer, an acrylic polymer, an organosilicon or a fluoro-contained polymer, or, is a mixture of the above material.

(d) The hydrophilic auxiliary 31 and the penetrant agent 41 are filled into the containing area 11 through the second filling unit 3 and the third filling unit 4, respectively, to process the fabric 6 with the setting unit 1 under a pick-up ratio of 50%˜58% and then to hot-drying the fabric 6 at a temperature of 130° C.˜180° C. for a time period of 1˜10 min. Therein, the hydrophilic auxiliary has a ratio of 0.1%˜10% to water; the hydrophilic auxiliary is a cation-type silicon, an amino silicon or a nonionic-type silicon, or, is a mixture of the above material; the penetrant agent has a ratio of 0.1%˜10% to water; and, the penetrant agent is a fatty acid derivative, an anion surfactant or an alcohol, or, is a mixture of the above material.

Thus, the fabric 6 has fast spreading of water by using the hydrophobic auxiliary 21, enhanced wetting effect by using the hydrophilic auxiliary 31 and compact hydrophilicity by using the penetrant agent 41. Furthermore, the fabric 6 obtains better spreading effect after absorbing water and better drying effect after washing through the above processes. The fabric 6 thus obtains effect of quick drying. Conclusively, with a natural fiber regardless of its count number, the fabric 6 keeps its hygroscopicity through functional finished treatment with a constant effect of quick drying.

To sum up, the present invention is a method of manufacturing a natural, breathable and quick drying fabric, where a fabric obtains both hydrophilicity and hydrophobicity at the same time; and water absorbed by the fabric is spread in a stereo way to keep hygroscopicity and obtain a constant function of quick drying.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of manufacturing a natural, breathable and quick drying fabric, comprising steps of:
(a) obtaining a setting unit,
wherein said setting unit has a containing area;
wherein said containing area contains a first filling unit, a second filling unit, a third filling unit and a drying unit; and
wherein said first filling unit, said second filling unit and said third filling unit are filled with a hydrophobic auxiliary, a hydrophilic auxiliary and a penetrant agent, respectively;
(b) obtaining a desized fabric in said containing area of said setting unit;
(c) filling said hydrophobic auxiliary into said containing area through said first filling unit to process said fabric with said setting unit and then to hot-drying said fabric with said drying unit; and
(d) filling said hydrophilic auxiliary and said penetrant agent into said containing area through said second filling unit and said third filling unit, respectively, to process said fabric with said setting unit and then to hot-drying said fabric.

2. The method according to claim 1,
wherein said setting unit has a pick-up ratio of 50%˜58%.

3. The method according to claim 1,
wherein said fabric is obtained by weaving a natural hydrophilic fiber.

4. The method according to claim 3,
wherein said natural fiber is selected from a group consisting of a plant fiber, an animal fiber and a mineral fiber.

5. The method according to claim 1,
wherein said hydrophobic auxiliary has a ratio of 0.1%˜10% to water.

6. The method according to claim 1,
wherein said hydrophobic auxiliary is selected from a group consisting of a material and a mixture of said material; and said material is selected from a group consisting of a wax, a sulphoisophthalic polymer, an acrylic polymer, an organosilicon and a fluoro-contained polymer.

7. The method according to claim 1,
wherein said hydrophilic auxiliary has a ratio of 0.1%˜10% to water.

8. The method according to claim 1,
wherein said hydrophilic auxiliary is selected from a group consisting of a material and a mixture of said material; and said material is selected from a group consisting of a cation-type silicon, an amino silicon and a nonionic-type silicon.

9. The method according to claim 1,
wherein said penetrant agent has a ratio of 0.1%˜10% to water.

10. The method according to claim 1,
wherein said penetrant agent is selected from a group consisting of a material and a mixture of said material; and said material is selected from a group consisting of a fatty acid derivative, an anion surfactant and an alcohol.

11. The method according to claim 1,
wherein said drying unit processes said hot-drying at a temperature of 130˜180 Celsius degrees (° C.) for a time period of 1˜3 minutes (min).
